(19) United States
(12) Patent Application Publication
(10) Pub. No.: US 2024/0017511 A1
(43) Pub. Date: Jan. 18, 2024

(54) ASSEMBLY MODULE

(71) Applicant: FIVEGRAND INTERNATIONAL CO., LTD., New Taipei City (TW)

(72) Inventor: TING-JUI WANG, New Taipei City (TW)

(21) Appl. No.: 18/349,189

(22) Filed: Jul. 10, 2023

(30) Foreign Application Priority Data
Jul. 14, 2022 (TW) 111126417
Jul. 14, 2022 (TW) 111126418

(51) Int. Cl. B30B 11/00

(52) U.S. Cl. CPC B30B 11/001

(57) ABSTRACT

An assembly module includes a first assembly mold, a second assembly mold and at least one coupling mold. The first assembly mold has at least one first setup portion, the second assembly mold has at least one second setup portion, and the second assembly mold corresponds to the first assembly mold. The coupling mold is removably disposed at a position corresponding to the at least one first setup portion, at least one second setup portion, or the least one first setup portion and the at least one second setup portion. The coupling mold is provided with a limiting portion, and the first assembly mold or the second assembly mold is provided with a corresponding limiting portion. The coupling mold provides mutual corresponding limiting or anti-rotation against the corresponding limiting portion by using the limiting portion.

### CROSS-REFERENCE TO RELATED APPLICATION

This non-provisional application claims priority under 35 U.S.C. § 119(a) on Patent Application No(s). 111126417 filed in Taiwan, R.O.C. on Jul. 14, 2022, and Patent Application No(s). 111126418 filed in Taiwan, R.O.C. on Jul. 14, 2022, the entire contents of which are hereby incorporated by reference.

### BACKGROUND OF THE INVENTION

### 1. Field of the Invention

The present disclosure relates to an assembly module, and in particular to an assembly module to couple a required element to an assembled object, achieving effects of ease of operation and quick assembly.

### 2. Description of the Related Art

An assembly module of common elements usually involves multiple assembly apparatus and processes according to components to be assembled, leading to numerous operation complications and hence affecting the assembly speed.

Therefore, the present disclosure aims at providing an assembly module capable of coupling a required element to an assembled object, achieving objects of ease of operation and quick assembly.

### BRIEF SUMMARY OF THE INVENTION

In view of the issues of the prior art above, in order to overcome these shortcomings, the applicant has dedicated to research and development to provide an assembly module in the aim of coupling a required element to an assembled object, so as to achieve the objects of ease of operation and quick assembly.

To achieve the above and other objects, the present disclosure provides an assembly module, including: a first assembly mold, having at least one first setup portion; and at least one coupling mold, removably disposed at the at least one first setup portion, wherein the coupling mold is provided with a limiting portion, the first assembly mold is provided with a corresponding limiting portion, and the coupling mold provides mutual corresponding limiting or anti-rotation against the corresponding limiting portion by using the limiting portion.

The present disclosure further provides another assembly module, including: a first assembly mold, having at least one first setup portion; and at least one coupling mold, removably disposed at the at least one first setup portion, wherein the first setup portion or the coupling mold is provided with a sensor or an energy body, the sensor or the energy body is for sensing and reporting information, setup information or a signal of the coupling mold, or the sensor or the energy body is for the coupling mold or the first setup portion to perform a hot melt, welding, pressurization, heating, magnetic attraction, moving, pneumatic, oil hydraulic, liquid hydraulic, conductive or electrical motion.

The present disclosure further provides another assembly module, including: a first assembly mold, a second assembly mold and at least one coupling mold. The first assembly mold has at least one first setup portion, the second assembly mold has at least one second setup portion, and the second assembly mold corresponds to the first assembly mold. The coupling mold is removably disposed at a position corresponding to the at least one first setup portion, at least one second setup portion, or the least one first setup portion and the at least one second setup portion. The coupling mold is provided with a limiting portion, and the first assembly mold or the second assembly mold is provided with a corresponding limiting portion. The coupling mold provides mutual corresponding limiting or anti-rotation against the corresponding limiting portion by using the limiting portion.

The present disclosure further provides another assembly module, including: a first assembly mold or a second assembly mold, and at least one coupling mold. The first assembly mold has at least one first setup portion, or the second assembly mold has at least one second setup portion. The coupling mold is removably disposed at the at least one first setup portion or the at least one second setup portion. The coupling mold is provided with a limiting portion, and the first assembly mold or the second assembly mold is provided with a corresponding limiting portion. The coupling mold provides mutual corresponding limiting or anti-rotation against the corresponding limiting portion by using the limiting portion.

The present disclosure further provides another assembly module, including: a first assembly mold, having at least one first setup portion; a second assembly mold, having at least one second setup portion, the second assembly mold corresponding to the first assembly mold; and at least one coupling mold, removably disposed at a position corresponding to the at least one first setup portion, the at least one second setup portion, or the at least one first setup portion and the at least one second setup portion, wherein the first setup portion, the second setup portion or the coupling mold is provided with a sensor, and the sensor is for sensing and reporting information, setup information or a signal of the coupling mold or is for the coupling mold, the first setup portion or the second setup portion to perform a hot melt, welding, pressurization, heating, magnetic attraction, moving, pneumatic, oil hydraulic, liquid hydraulic, conductive or electrical motion.

The present disclosure further provides another assembly module, including: a first assembly mold, having at least one first setup portion, or a second assembly mold, having at least one second setup portion; and at least one coupling mold, removably disposed at the at least one first setup portion or the at least one second setup portion, wherein the first setup portion, the second setup portion or the coupling mold is provided with a sensor, the sensor is for sensing and reporting information, setup information or a signal of the coupling mold or is for the coupling mold, the first setup portion or the second setup portion to perform a hot melt, welding, pressurization, heating, magnetic attraction, moving, pneumatic, oil hydraulic, liquid hydraulic, conductive or electrical motion.

In the assembly module above, the coupling mold is an elastic mold, a buffer mold or a pressurizing mold provided with an elastic element or a buffer element.

In the assembly module above, the coupling mold is consisted of multiple elements.

In the assembly module above, the coupling mold is planar, convex, concave, arched, stepped, circular, sloped or ellipsoidal in shape.

In the assembly module above, the first assembly mold or the second assembly mold is drawably disposed in an assembly apparatus or a structure.

In the assembly module above, the assembly apparatus or the structure is a slide rail, a track, a drawer, a recess, a protrusion or a slot.

In the assembly module above, the first assembly mold or the second assembly mold is disposed at the coupling mold and then limited by the assembly apparatus or the structure.

In the assembly module above, the limiting portion of the coupling mold is for providing limiting or anti-rotation against a corresponding limiting portion of an assembled object, or for providing limiting or anti-rotation against the assembled object, or for providing limiting or anti-rotation against an assembly direction of the assembled object, or for achieving mutual alignment setting directions or mutual alignment of the assembled object and an object.

In the assembly module above, the first setup portion is provided as plural in quantity in a matrix arrangement, or the second setup portion is provided as plural in quantity in a matrix arrangement.

In the assembly module above, the first setup portions have assembly code information, the coupling mold has coupling code information, and the coupling code information of the coupling mold corresponds to the assembly code information of the first setup portions. Or, the second setup portions have assembly code information, the coupling mold has coupling code information, and the coupling code information of the coupling mold corresponds to the assembly code information of the second setup portions.

In the assembly module above, the coupling mold, the first setup portion or the second setup portion is for performing a hot melt, welding, pressurization, heating, magnetic attraction, moving, pneumatic, oil hydraulic, liquid hydraulic, conductive or electrical motion.

In the assembly module above, the sensor senses or obtains information, setup information or a signal of the coupling mold, and reports the information to an information system.

In the assembly module above, the sensor is electrically connected to an information system by a circuit, or the sensor is wirelessly connected to an information system.

In the assembly module above, the first setup portion, the second setup portion or the coupling mold has a light emitter, and the light emitter is for displaying the information, setup information or signal of the coupling mold.

In the assembly module above, the light emitter is electrically connected to the sensor by a circuit, or the light emitter is wirelessly connected to the sensor.

In the assembly module above, the coupling mold is provided with an elastic element or a buffer element, and the elastic element or buffer element is gas, liquid or an elastic body for providing a buffering, elastic, resistive or pressurizing force.

In the assembly module above, the coupling mold is provided with a limiting portion, and the first assembly mold or the second assembly mold is provided with a corresponding limiting portion. The coupling mold provides mutual corresponding limiting or anti-rotation against the corresponding limiting portion by using the limiting portion.

In the assembly module above, the sensor is a light emitter, an electrified body, a gas passable body, an oil passable body or a liquid passable body.

In the assembly module above, the electrified body, gas passable body, oil passable body or liquid passable body can be used for the coupling mold to hot melt, weld, pressurize or heat an assembled body, or for the assembly module to perform a moving, pneumatic, oil hydraulic, liquid hydraulic, conductive or electrical motion.

In the assembly module above, the sensor is a switch, a switch structure, a valve structure, a quick release structure, a fastening structure, an activator, an activation structure, a connector structure, a quick connector structure, a press structure, an LED, a sensor, a scanner or a button.

The assembly module above further includes a suction body, and the suction body is disposed at the first setup portion or the second setup portion.

In the assembly module above, the suction body is a magnet, an electromagnet, or a substance having magnetism or attraction.

Thus, the assembly module of the present disclosure is capable of coupling a required element to an assembled object, achieving effects of ease of operation and quick assembly.

### BRIEF DESCRIPTION OF THE DRAWINGS

FIG. 1 is a schematic diagram of an appearance according to a first embodiment of the present disclosure.

FIG. 2 is a first schematic diagram of a state of use according to the first embodiment of the present disclosure.

FIG. 3 is a second schematic diagram of a state of use according to the first embodiment of the present disclosure.

FIG. 4 is a third schematic diagram of a state of use according to the first embodiment of the present disclosure.

FIG. 5 is a schematic diagram of different forms of a coupling mold of the present disclosure.

FIG. 6 is a schematic diagram of a state of use according to a second embodiment of the present disclosure.

FIG. 7 is a schematic diagram of a state of use according to a third embodiment of the present disclosure.

FIG. 8 is a schematic diagram of a state of use according to a fourth embodiment of the present disclosure.

FIG. 9 is a first schematic diagram of a state of use according to a fifth embodiment of the present disclosure.

FIG. 10 is a second schematic diagram of a state of use according to the fifth embodiment of the present disclosure.

FIG. 11 is a schematic diagram of an appearance according to a sixth embodiment of the present disclosure.

FIG. 12 is a first schematic diagram of a state of use according to the sixth embodiment of the present disclosure.

FIG. 13 is a second schematic diagram of a state of use according to the sixth embodiment of the present disclosure.

FIG. 14 is a third schematic diagram of a state of use according to the sixth embodiment of the present disclosure.

FIG. 15 is a schematic diagram of different forms of a coupling mold of the present disclosure.

FIG. 16 is a schematic diagram of a state of use according to a seventh embodiment of the present disclosure.

FIG. 17 is a schematic diagram of a state of use according to an eighth embodiment of the present disclosure.

### DETAILED DESCRIPTION OF THE INVENTION

To facilitate understanding of the object, characteristics and effects of the present disclosure, embodiments together with the attached drawings for the detailed description of the present disclosure are provided.

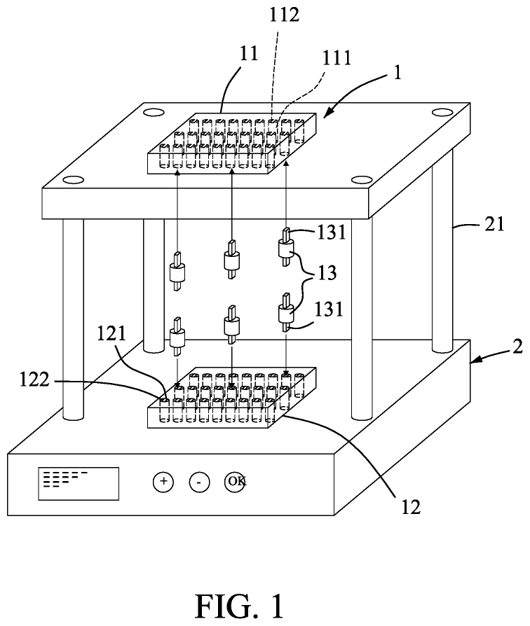

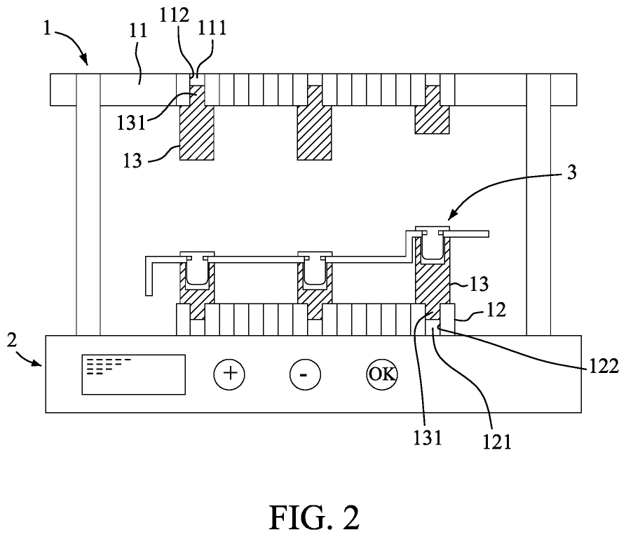

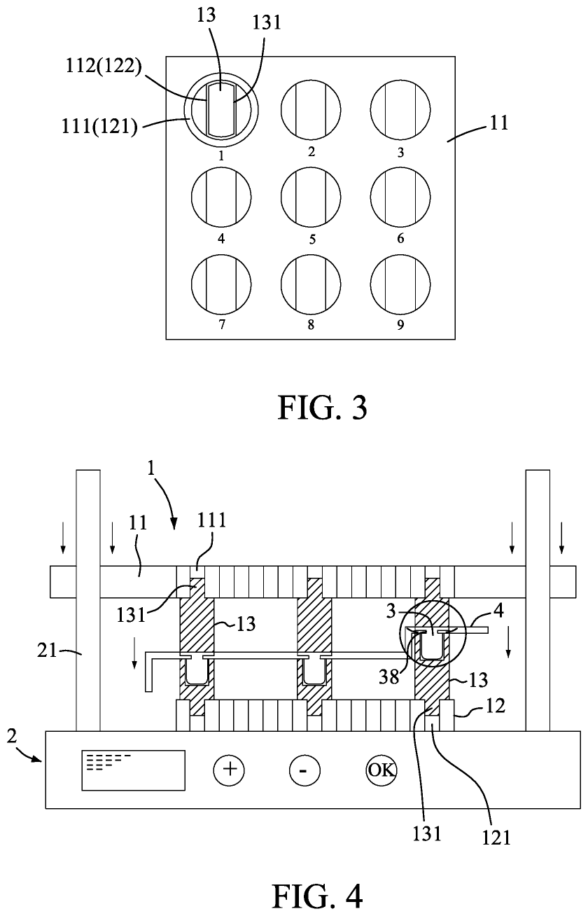

Refer to FIG. 1 to FIG. 4. As shown in the drawings, the present disclosure provides an assembly module 1. In one embodiment, the assembly module 1 includes a first assembly mold 11 and at least one coupling mold 13. The first assembly mold 11 has at least one first setup portion 111. The coupling mold 13 is removably disposed at the at least one first setup portion 111. The coupling mold 13 is provided with a limiting portion 131, the first assembly mold 11 is provided with a corresponding limiting portion 112, and the coupling mold 13 provides mutual corresponding limiting or anti-rotation against the corresponding limiting portion 112 by using the limiting portion 131.

When the above embodiment is assembled and used, the first assembly mold 11 is disposed at an assembly apparatus 2. The assembly apparatus 2 has at least one downward pressing portion 21, and the at least one coupling mold 13 is assembled or replaced on the first setup portions 111 according to an assembled object 3 set up in advance, so as to enable the coupling molds 13 to meet assembly requirements of the assembled object 3. In addition, mutual corresponding limiting and hence anti-rotation are formed by the limiting portion 131 of the coupling molds 13 and the corresponding limiting portion 112 of the first assembly mold 11, so as to maintain the stability of the coupling molds 13 assembled at the first assembly mold 11. Then, the downward pressing portion 21 of the assembly apparatus 2 is pressed downward to pressurize the assembled object 3, and assembly steps needed for the assembled object 3 are performed by using the coupling molds 13, thereby achieving the objects of ease of operation and quick assembly.

The assembly module 1 according to another embodiment of the present disclosure includes a first assembly mold 11, a second assembly mold 12 and at least one coupling mold 13 as an implementation example for illustrations.

The first assembly mold 11 has at least one first setup portion 111, and in one embodiment of the present disclosure, at least one first setup portion 111 is provided.

The second assembly mold 12 has at least one second setup portion 121, the second assembly mold 12 corresponds to the first assembly mold 11, and in one embodiment of the present disclosure, at least one second setup portion 121 is provided.

The coupling mold 13 is removably disposed at a position corresponding to the at least one first setup portion 111, at least one second setup portion 121, or the least one first setup portion 111 and the at least one second setup portion 121. The coupling mold 13 is provided with a limiting portion 131, and the first assembly mold 11 or the second assembly mold 12 is provided with a corresponding limiting portion 112 or 122. The coupling mold 13 provides mutual corresponding limiting or anti-rotation against the corresponding limiting portion 112 or 122 by using the limiting portion 131.

Moreover, the assembly module 1 may also include only the first assembly mold 11 and the coupling mold 13, or only the second assembly mold 12 and the coupling mold 13, and the coupling mold 13 is removably disposed at a position corresponding to the at least one first setup portion 111 or the at least one second setup portion 121. The coupling mold 13 is provided with a limiting portion 131, and the first assembly mold 11 or the second assembly mold 12 is provided with a corresponding limiting portion 112 or 122. The coupling mold 13 provides mutual corresponding limiting or anti-rotation against the corresponding limiting portion 112 or 122 by using the limiting portion 131.

For assembly and use, multiple coupling molds 13 are used in one embodiment of the present disclosure. The first assembly mold 11 and the second assembly mold 12 are disposed at an assembly apparatus 2. The assembly apparatus 2 has at least one downward pressing portion 21, and the coupling molds 13 are assembled or replaced on the first setup portions 111 and the second setup portions 121 according to an assembled object 3 set up in advance, so as to enable the coupling molds 13 to meet assembly requirements of the assembled object 3. In addition, during assembly of the coupling molds 13, mutual corresponding limiting and hence anti-rotation are formed by the limiting portions 131 of the coupling molds 13 and the corresponding limiting portion 112 of the first assembly mold 11 and the corresponding limiting portion 122 of the second assembly mold 12, so as to maintain the stability of the coupling molds 13 assembled at the first assembly mold 11 and the second assembly mold 12. Then, the downward pressing portion 21 of the assembly apparatus 2 is pressed downward to pressurize the assembled object 3, and assembly steps needed for the assembled object 3 are performed by using the coupling molds 13, thereby achieving the objects of ease of operation and quick assembly.

In one embodiment of the present disclosure, the first setup portions 111 are in a matrix arrangement, and/or the second setup portions 121 are in a matrix arrangement.

In one embodiment of the present disclosure, the first setup portions 111 have assembly code information, the coupling molds 13 have coupling code information, and the coupling code information of the coupling molds 13 corresponds to the assembly code information of the first setup portions 111, and/or the second setup portions 121 have assembly code information, the coupling molds 13 have coupling code information, and the coupling code information of the coupling molds 13 corresponds to the assembly code information of the second setup portions 121.

On the basis of the embodiment above, in practice, numerals, texts or graphics may be marked for the first setup portions 111 and the second setup portions 121 as the assembly code information, and numerals, texts or graphics may be marked for the coupling molds 13 as the coupling code information, for a user to perform related coupling according to the assembly code information of the first setup portions 111, the assembly code information of the second setup portions 121, and the coupling code information of the coupling molds 13.

Moreover, the assembly code information of the first setup portions 111, the assembly code information of the second setup portions 121 and the coupling code information of the coupling molds 13 may be digitally edited and stored in the assembly apparatus 2 or in an external computer, for the assembly apparatus 2 to perform related coupling in an automated manner according to the assembly code information of the first setup portions 111, the assembly code information of the second setup portions 121, and the coupling code information of the coupling molds 13.

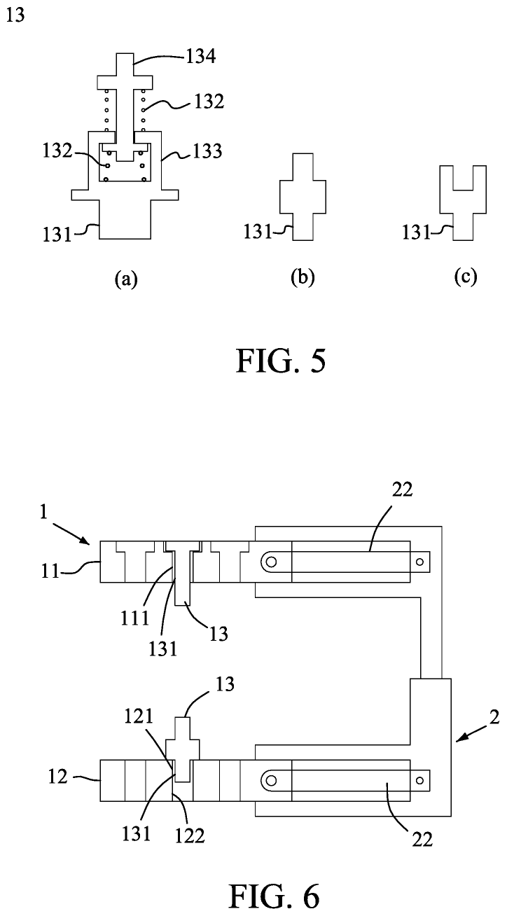

Refer to FIG. 5. As shown in the drawing, in one embodiment of the present disclosure, a difference from the above embodiments is that, the coupling mold 13 is an elastic mold, a buffer mold or a pressurizing mold provided with an elastic element 132 (or a buffer element). Thus, the requirement for elastic pressure, elastic restoration and buffering can be achieved according to assembly steps or procedures of different assembled objects 3.

In one embodiment of the present disclosure, the coupling mold 13 is consisted of multiple elements. For example, the coupling mold 13 has an elastic element 132, a body 133 and an assembly portion 134. The assembly portion 134 is movably disposed at the body 133, and the elastic element 132 is disposed between the body 133 and the assembly portion 134 (as part a shown in FIG. 5). Moreover, the coupling mold 13 may also be planar, convex (as part b shown in FIG. 5), concave (as part c shown in FIG. 5), arched, stepped, circular, sloped or ellipsoidal in shape according to requirements. Thus, the coupling mold 13 in different forms can be selected according to assembly steps or procedures of different assembled objects 3.

In one embodiment of the present disclosure, the coupling mold 13, the first setup portion 111 or the second setup portion 112 is for performing a hot melt, welding, pressurization, heating, magnetic attraction, moving, pneumatic, oil hydraulic, liquid hydraulic, conductive or electrical motion.

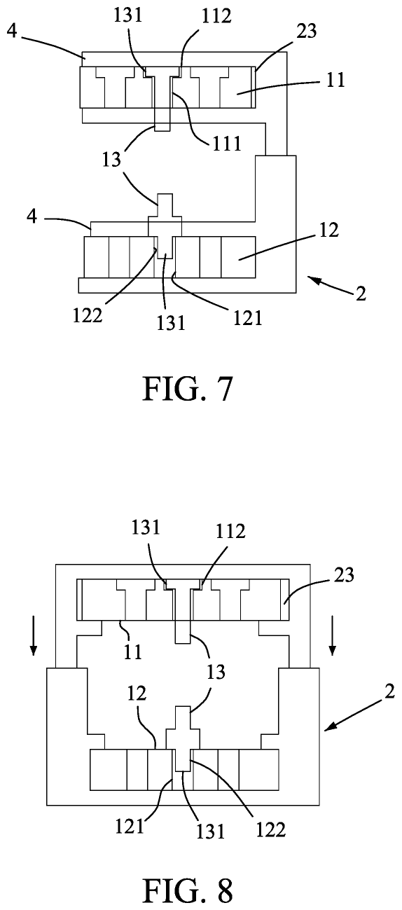

Refer to FIG. 6 to FIG. 8. As shown in the drawings, in one embodiment of the present disclosure, a difference from the above embodiments is that, the first assembly mold 11 or the second assembly mold 12 may be drawably disposed at the assembly apparatus 2 (as shown in FIG. 6 or FIG. 7) or a structure 4 (as shown in FIG. 8), wherein the assembly apparatus 2 (or the structure) may be a slide rail (as shown in FIG. 6), a track 23 (as shown in FIG. 7), a drawer, a recess, a protrusion or a slot. Thus, the first assembly mold 11 or the second assembly mold 12 can be limited by the assembly apparatus 2 or the structure 4 after being disposed at the coupling mold 13, so as to maintain the stability of the coupling mold 13 assembled at the first assembly mold 11 and the second assembly mold 12 in course of the assembly operation thereof.

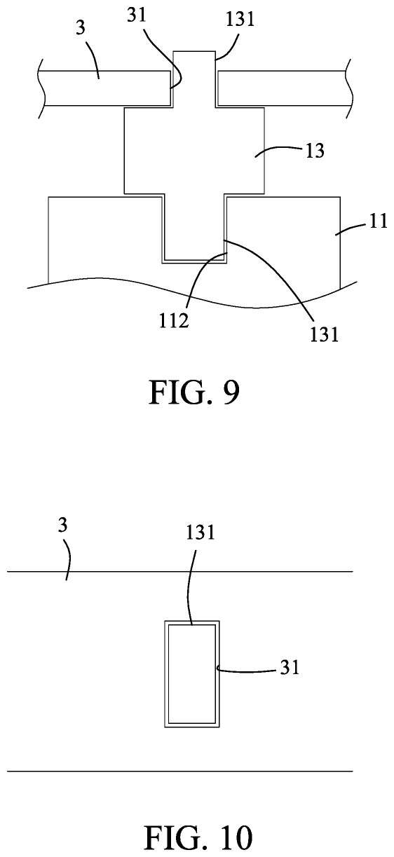

Refer to FIG. 9 and FIG. 10. As shown in the drawings, in one embodiment of the present disclosure, a difference from the above embodiments is that, the limiting portion 131 of the coupling mold 13 is for providing limiting or anti-rotation against the corresponding limiting portion 31 of the assembled object 3, or for providing limiting or anti-rotation against the assembled object 3, or for providing limiting or anti-rotation against an assembly direction of the assembled object 3, or for achieving mutual alignment setting directions or mutual alignment of the assembled object 3 and an object (not shown).

In one embodiment of the present disclosure, a difference from the above embodiments is that, the first assembly mold 11 or the second assembly mold 12 is provided with a corresponding limiting portion 112 or 122. The coupling mold 13 provides mutual corresponding limiting or anti-rotation against the corresponding limiting portion 112 or 122 by using the limiting portion 131.

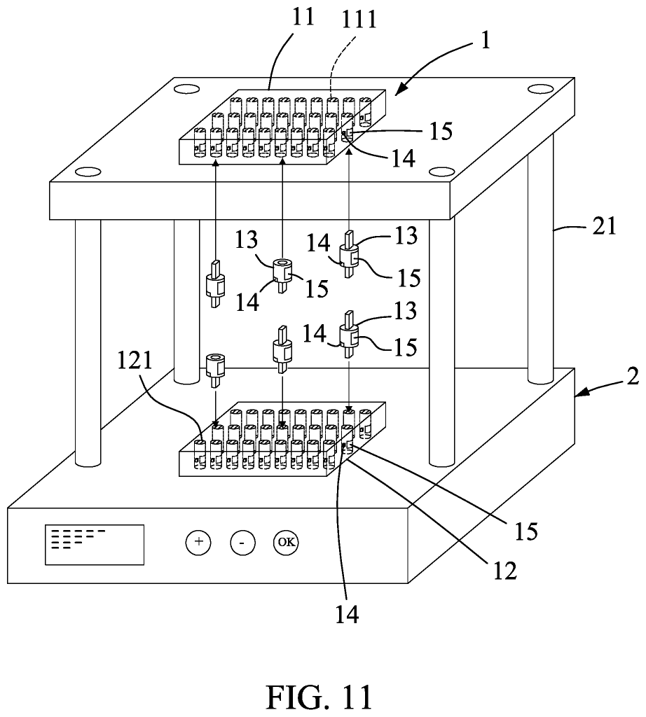

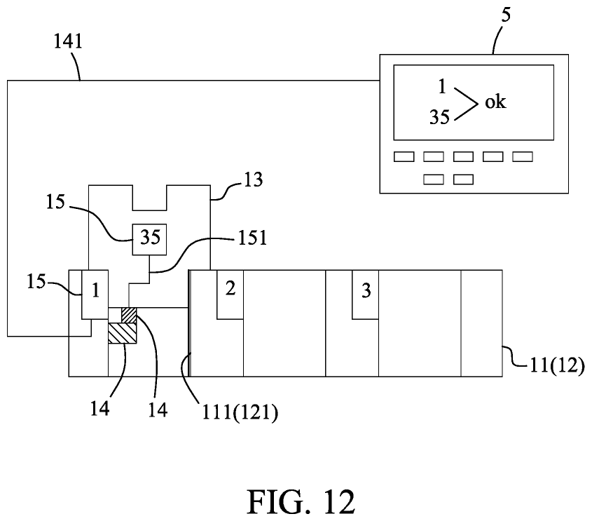

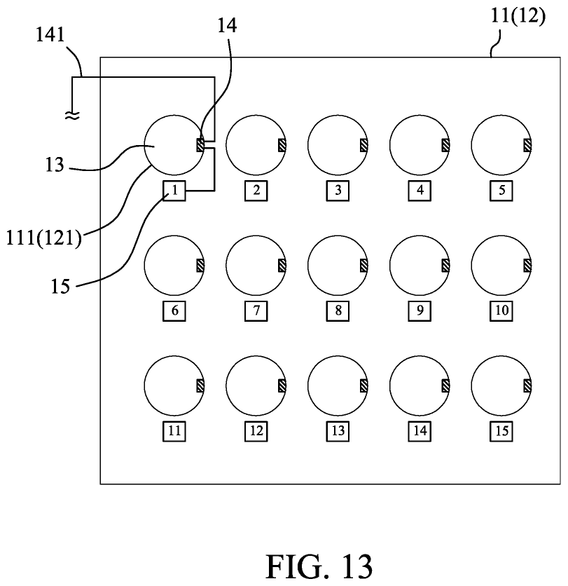

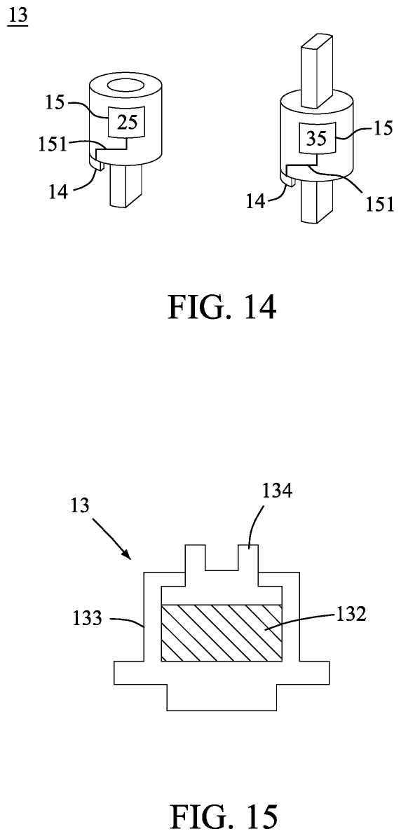

Refer to FIG. 11 to FIG. 14. As shown in the drawings, the present disclosure further provides an assembly module 1. In one embodiment, the assembly module 1 includes a first assembly mold 11 and at least one coupling mold 13. The first assembly mold 11 has at least one first setup portion 111. The coupling mold 13 is removably disposed at the at least one first setup portion 111, the first setup portion 111 or the coupling mold 13 is provided with a sensor 14 (or an energy body, wherein the energy body may be an electrical substance, a magnetic substance, or other substances having energy, wherein the electrical substance is, for example, an LED or a power sensor, and the magnetic substance is, for example, a magnet or an electromagnet; in one embodiment of the present disclosure, the sensor 14 is used), the sensor or the energy body is for sensing and reporting information, setup information or a signal of the coupling mold, or the sensor or the energy body is for the coupling mold or the first setup portion to perform a hot melt, welding, pressurization, heating, magnetic attraction, moving, pneumatic, oil hydraulic, liquid hydraulic, conductive or electrical motion.

When the above embodiment is assembled and used, the first assembly mold 11 is disposed at an assembly apparatus 2, and the at least one coupling mold 13 is assembled or replaced on the first setup portions 111 according to the assembled object 3 set up in advance, so as to enable the coupling mold 13 to meet assembly requirements of the assembled object 3. In addition, the information, setup information or signal of the coupling molds 13 is sensed and reported by the sensor 14, such that the assembly status of the coupling molds 13 and the first assembly mold 11 is learned. Then, the downward pressing portion 21 of the assembly apparatus 2 is pressed downward to pressurize the assembled object 3, and assembly steps needed for the assembled object 3 are performed by using the coupling molds 13, thereby achieving the objects of ease of operation and quick assembly.

The assembly module 1 according to another embodiment of the present disclosure includes a first assembly mold 11, a second assembly mold 12 and at least one coupling mold 13 as an implementation example for illustrations.

The first assembly mold 11 has a plurality of first setup portions 111.

The second assembly mold 12 has a plurality of second setup portions 121, and the second assembly mold 12 corresponds to the first assembly mold 11.

The coupling mold 13 is removably disposed at a position corresponding to the at least one first setup portion 111, the at least one second setup portion 121, or the at least one first setup portion 111 and the at least one second setup portion 121. The first setup portion 111, the second setup portion 121 or the coupling mold 13 is provided with a sensor 14. The sensor 14 is for sensing and reporting information, setup information or a signal of the coupling mold 13 or is for the coupling mold 13, the first setup portion 111 or the second setup portion 121 to perform a hot melt, welding, pressurization, heating, magnetic attraction, moving, pneumatic, oil hydraulic, liquid hydraulic, conductive or electrical motion.

Moreover, the assembly module 1 may also include only the first assembly mold 11 and the coupling mold 13, or only the second assembly mold 12 and the coupling mold 13. The coupling mold 13 is removably disposed at a position corresponding to the at least one first setup portion 111 or the at least one second setup portion 121. The first setup portion 111, the second setup portion 121 or the coupling mold 13 is provided with a sensor 14. The sensor 14 is for sensing and reporting information, setup information or a signal of the coupling mold 13 or is for the coupling mold 13, the first setup portion 111 or the second setup portion 121 to perform a hot melt, welding, pressurization, heating, magnetic attraction, moving, pneumatic, oil hydraulic, liquid hydraulic, conductive or electrical motion.

For assembly and use, multiple coupling molds 13 are used in one embodiment of the present disclosure. The first assembly mold 11 and the second assembly mold 12 are disposed at an assembly apparatus 2. The assembly apparatus 2 has at least one downward pressing portion 21, and the coupling molds 13 are assembled or replaced on the first setup portions 111 and the second setup portions 121 according to an assembled object (not shown) set up in advance, so as to enable the coupling molds 13 to meet assembly requirements of the assembled object. In addition, during assembly of the coupling molds 13, the information, setup information or signal of the coupling molds 13 is sensed and reported by the sensors 14, such that the assembly status of the coupling molds 13, the first assembly mold 11 and the second assembly mold 12 are learned. Then, the downward pressing portion 21 of the assembly apparatus 2 is pressed downward to pressurize the assembled object, and assembly steps needed for the assembled object are performed by using the coupling molds 13, thereby achieving the objects of ease of operation and quick assembly.

In one embodiment of the present disclosure, the sensors 14, after sensing or obtaining the information, setup information or signal of the coupling molds 13, reports the information to an information system 5, wherein the sensors 14 are respectively connected to the information system 5 by circuits 141 (or the sensors 14 are respectively wirelessly connected to the information system 5). Thus, when the coupling molds 13 are assembled, the information, setup information or signal of the coupling molds 13 is sensed and reported by the sensors 14 to the information system 5, for the information system 5 to transmit the information, setup information or signal received to the assembly apparatus 2, such that the assembly status of the coupling molds 13, the first assembly mold 11 and the second assembly mold 12 is learned. Then, the downward pressing portion 21 of the assembly apparatus 2 is pressed downward to pressurize the assembled object, and assembly steps needed for the assembled object are performed by using the coupling molds 13, thereby achieving the objects of ease of operation and quick assembly.

In one embodiment of the present disclosure, the first setup portion 111, the second setup portion 121 or the coupling mold 13 is provided with a light emitter 15 (for example, a light emitting diode). The light emitters 15 are for displaying the information, setup information or signal of the coupling mold 13, and the light emitters 15 are electrically connected to the sensors 14 by circuits 151 (or the light emitters 15 are respectively wirelessly connected to the sensors 14).

Thus, when the coupling molds 13 are assembled, in addition to sensing and reporting the information, setup information or signal of the coupling molds 13 by the sensors 14 to the information system 5, when the coupling molds 13 are assembled, the information, setup information or signal of the coupling molds 13 can be further displayed by the light emitters 15, and is altogether transmitted with the information, setup information or signal of the coupling molds 13 sensed by the sensors 14 to the information system 5, for the information system 5 to transmit the information, setup information or signal received to the assembly apparatus 2, such that the assembly status of the coupling molds 13, the first assembly mold 11 and the second assembly mold 12 is learned. Then, the downward pressing portion 21 of the assembly apparatus 2 is pressed downward to pressurize the assembled object, and assembly steps needed for the assembled object are performed by using the coupling molds 13, thereby achieving the objects of ease of operation and quick assembly.

In one embodiment of the present disclosure, the sensors 14 may be switches, switch structures, valve structures, quick release structures, fastening structures, activators, activation structures, connector structures, quick connector structures, press structures, LEDs, sensors, scanners or buttons.

Refer to FIG. 15. As shown in the drawing, in one embodiment of the present disclosure, a difference from the above embodiments is that, the coupling mold 13 is provided with an elastic element 132, and the elastic element 132 is gas, liquid or a buffer element (in this embodiment, the elastic element 132 is a buffer) for providing a buffering, elastic, resistive or pressurizing force. Thus, the requirement for elastic pressure, elastic restoration and buffering can be achieved according to assembly steps or procedures of different assembled objects.

In one embodiment of the present disclosure, the coupling mold 13 is consisted of multiple elements. For example, the coupling mold 13 has an elastic element 132, a body 133 and an assembly portion 134. The assembly portion 134 is movably disposed at the body 133, and the elastic element 132 is disposed between the body 133 and the assembly portion 134. Thus, the coupling mold 13 in different forms can be selected according to assembly steps or procedures of different assembled objects.

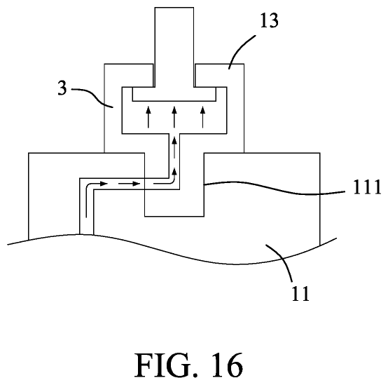

Refer to FIG. 16. As shown in the drawing, in one embodiment of the present disclosure, a difference from the above embodiments is that, the sensor 14 has an electrified body, a gas passable body, an oil passable body or a liquid passable body, or the sensor 14 can be an electrified body, a gas passable body, an oil passable body or a liquid passable body, wherein the electrified body, the gas passable body, the oil passable body or the liquid passable body can be used for the coupling mold 13 to hot melt, weld, pressurize or heat the assembled object 3, or for the assembly module 1 to perform a moving, pneumatic, oil hydraulic, liquid hydraulic, conductive or electrical motion.

Again refer to FIG. 9 and FIG. 10. As shown in the drawings, the first assembly mold 11 or the second assembly mold 12 is provided with a corresponding limiting portion 112 or 122, and the coupling mold 13 provides mutual corresponding limiting or anti-rotation against the corresponding limiting portion 112 or 122 by using the limiting portion 131. For assembly and use, in addition to sensing the information, setup information or signal of the coupling molds 13 by the sensors 14 above, and/or displaying the information, setup information or signal by the light emitters 15, during assembly of the coupling molds 13, mutual corresponding limiting and hence anti-rotation are formed by the limiting portions 131 of the coupling molds 13 and the corresponding limiting portion 112 of the first assembly mold 11 and the corresponding limiting portion 122 of the second assembly mold 12, so as to maintain the stability of the coupling molds 13 assembled at the first assembly mold 11 and the second assembly mold 12. Then, the downward pressing portion 21 of the assembly apparatus 2 is pressed downward to pressurize the assembled object, and assembly steps needed for the assembled object are performed by using the coupling molds 13, thereby achieving the objects of ease of operation and quick assembly.

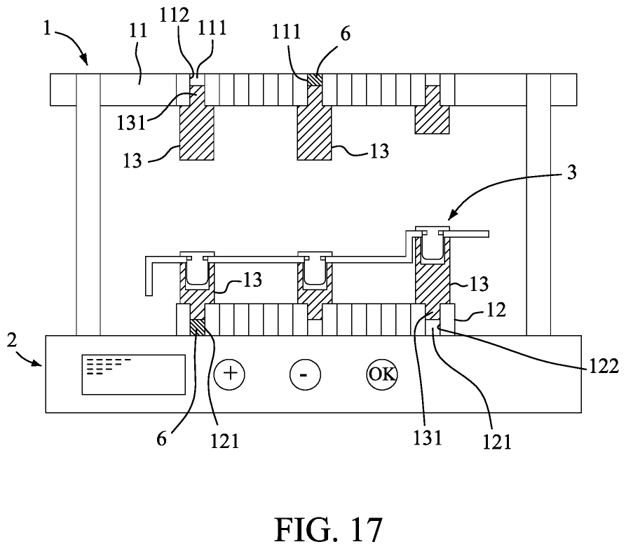

Refer to FIG. 17. As shown in the drawing, in one embodiment of the present disclosure, a difference from the above embodiments is that, a suction body 6 is further included. The suction body 6 is disposed at the first setup portion 111 or the second setup portion 121, and can be a magnet, an electromagnet, or a substance having magnetism or attraction.

The suction body 6 attracts the coupling mold 13 to the first setup portion 111 or the second setup portion 121 (or the assembled object 3 is attracted by the suction body 6), thereby achieving the effect of quick assembly.

The present invention has been disclosed by way of the preferred embodiments above. A person skilled in the art should understand that, these embodiments are merely for illustrating the present invention and are not to be construed as limitations to the scope of the present invention. It should be noted that all equivalent changes, replacements and substitutions made to the embodiments are encompassed within the scope of the present invention. Therefore, the scope of legal protection of the present invention should be defined by the appended claims.

What is claimed is:

1. An assembly module, comprising:
a first assembly mold, having at least one first setup portion; and
at least one coupling mold, removably disposed at the at least one first setup portion, wherein the coupling mold is provided with a limiting portion, the first assembly mold is provided with a corresponding limiting portion, and the coupling mold provides mutual corresponding limiting or anti-rotation against the corresponding limiting portion by using the limiting portion.

2. The assembly module according to claim 1, wherein the coupling mold is an elastic mold, a buffer mold or a pressurizing mold provided with an elastic element or a buffer element.

3. The assembly module according to claim 1, wherein the limiting portion of the coupling mold is for providing limiting or anti-rotation against a corresponding limiting portion of an assembled object, or for providing limiting or anti-rotation against the assembled object, or for providing limiting or anti-rotation against an assembly direction of the assembled object, or for achieving mutual alignment setting directions or mutual alignment of the assembled object and an object.

4. The assembly module according to claim 1, wherein the first setup portion is provided as plural in quantity in a matrix arrangement, or the assembly module has at least one second setup portion, and the second setup portion is provided as plural in quantity in a matrix arrangement.

5. The assembly module according to claim 1, wherein the first setup portion is provided as plural in quantity, the first setup portions have assembly code information, or the coupling mold has coupling code information, or the coupling code information of the coupling mold corresponds to the assembly code information of the first setup portions; or the assembly module further comprises a second setup portion, the second setup portion has assembly code information, or the corresponding coupling mold has coupling code information, or the coupling code information of the coupling mold corresponds to the assembly code information of the second setup portions.

6. The assembly module according to claim 1, wherein the first setup portion or the coupling mold has a light emitter, and the light emitter is for displaying the information, setup information or signal of the first setup portion or the coupling mold.

7. The assembly module according to claim 1, wherein the coupling mold or the first setup portion is provided with an elastic element or a buffer element, and the elastic element or buffer element is gas, liquid or an elastic body for providing a buffering, elastic, resistive or pressurizing force.

8. The assembly module according to claim 1, wherein the coupling mold is provided with a limiting portion, the first assembly mold or the second assembly mold is provided with a corresponding limiting portion, and the coupling mold provides mutual corresponding limiting or anti-rotation against the corresponding limiting portion by using the limiting portion.

9. An assembly module, comprising:
a first assembly mold, having at least one first setup portion; and
at least one coupling mold, removably disposed at the at least one first setup portion, wherein the first setup portion or the coupling mold is provided with a sensor or an energy body, the sensor or the energy body is for sensing and reporting information, setup information or a signal of the coupling mold, or the sensor or the energy body is for the coupling mold or the first setup portion to perform a hot melt, welding, pressurization, heating, magnetic attraction, moving, pneumatic, oil hydraulic, liquid hydraulic, conductive or electrical motion.

10. The assembly module according to claim 9, wherein the coupling mold is an elastic mold, a buffer mold or a pressurizing mold provided with an elastic element or a buffer element.

11. The assembly module according to claim 9, wherein the limiting portion of the coupling mold is for providing limiting or anti-rotation against a corresponding limiting portion of an assembled object, or for providing limiting or anti-rotation against the assembled object, or for providing limiting or anti-rotation against an assembly direction of the assembled object, or for achieving mutual alignment setting directions or mutual alignment of the assembled object and an object.

12. The assembly module according to claim 9, wherein the first setup portion is provided as plural in quantity in a matrix arrangement, or the assembly module has at least one second setup portion, and the second setup portion is provided as plural in quantity in a matrix arrangement.

13. The assembly module according to claim 9, wherein the first setup portion is provided as plural in quantity, the first setup portions have assembly code information, or the coupling mold has coupling code information, or the coupling code information of the coupling mold corresponds to the assembly code information of the first setup portions; or the assembly module further comprises a second setup portion, the second setup portion has assembly code information, or the corresponding coupling mold has coupling code information, or the coupling code information of the coupling mold corresponds to the assembly code information of the second setup portions.

14. The assembly module according to claim 9, wherein the sensor or the energy body senses or obtains information, setup information or a signal of the coupling mold or the first setup portion, and then reports the information to an information system.

15. The assembly module according to claim 9, wherein the first setup portion or the coupling mold has a light emitter, and the light emitter is for displaying the information, setup information or signal of the first setup portion or the coupling mold.

16. The assembly module according to claim 9, wherein the coupling mold or the first setup portion is provided with an elastic element or a buffer element, and the elastic element or buffer element is gas, liquid or an elastic body for providing a buffering, elastic, resistive or pressurizing force.

17. The assembly module according to claim 9, wherein the coupling mold is provided with a limiting portion, the first assembly mold or the second assembly mold is provided with a corresponding limiting portion, and the coupling mold provides mutual corresponding limiting or anti-rotation against the corresponding limiting portion by using the limiting portion.
